(19) United States
(12) Patent Application Publication
(10) Pub. No.: US 2026/0044685 A1
(43) Pub. Date: Feb. 12, 2026

(54) METHOD AND SYSTEM FOR TRANSLATING CONTENT

(71) Applicant: NAVER WEBTOON LTD., Seongnam-si (KR)

(72) Inventors: Jae Han YOON, Seongnam-si (KR); Yu Jin HONG, Seongnam-si (KR); Ji Seon SIM, Seongnam-si (KR); Jun Eyoun MOON, Seongnam-si (KR); Jae Hyuk JANG, Seongnam-si (KR); Wan Been JOO, Seongnam-si (KR); Joo A CHA, Seongnam-si (KR); Ju Yul PARK, Seongnam-si (KR); Yu Jin CHUNG, Seongnam-si (KR); Young Sub CHOI, Seongnam-si (KR)

(21) Appl. No.: 18/980,938

(22) Filed: Dec. 13, 2024

(30) Foreign Application Priority Data
Aug. 6, 2024 (KR) 10-2024-0104876

(51) Int. Cl. G06F 40/58; G06V 20/62; G06V 30/10

(52) U.S. Cl. CPC G06F 40/58; G06V 20/62; G06V 30/10

(57) ABSTRACT

A method of translating content may include receiving an image file of a translation target related to an episode of content based on a first language, extracting text corresponding to the first language from the image file, and providing a translation editor for the image file so that a translated version of the episode is generated on the basis of a second language using the image file. The translation editor may include a first area in which the image file of the translation target is output, and a second area for receiving a translated language in the second language for the extracted text as input. In response to a control command for image capturing, at least a portion of the output image file is received through the first area, an input window for receiving a translated language for the captured image as input is generated in the second area.

### CROSS REFERENCE TO RELATED APPLICATION

The present application claims priority to Korean Patent Application No. 10-2024-0104876, filed on Aug. 6, 2024, the entire contents of which is incorporated herein for all purposes by this reference.

### BACKGROUND OF THE INVENTION

### Field of the Invention

The present invention relates to a method of translating content and a system for supporting the same.

### Description of the Related Art

As technology advances, the use of a digital device increases. In particular, an electronic device (e.g., smartphone, tablet PC, etc.) is equipped with various functions including communication functions such as a phone call or text message, as well as surfing the web, listening to music, and watching videos using the Internet.

With the popularization of the electronic device, the consumption of contents provided through the electronic device such as PC or mobile devices is rapidly increasing. For an example, there is webcomics. The webcomic is a comic serialized and distributed through an Internet communication network.

As the consumption of these webcomics continues to increase, various service providers (or webcomic-related service providers) are developing various services to secure users (or consumers, subscribers) who can use the services steadily.

For example, Korean Laid-Open Patent No. 10-2018-0119005 (a webtoon providing method using a sharing function) discloses a method of allowing a user owning a webcomic online to share the webcomic with other users. Those other users can read part of the webcomic and decide whether to make a purchase, thereby enabling users to purchase webcomics containing content of their preference.

Meanwhile, such webcomics go beyond being created by authors and provided as a service in their respective countries, and are now being serviced globally. Therefore, it is essential that they are translated into various languages of different countries. As described above, in order to enhance consumer purchase intent for content on a global scale, customized translation for each country is necessary. However, a systematic translation process for webcomics has not yet been established.

### SUMMARY OF THE INVENTION

The present invention relates to a method and system for translating content, thereby enabling users from a plurality of countries to continuously use the content.

Further, the present invention relates to a method of translating content, which is capable of providing a user environment optimized for translation tasks, and to a system that supports the same.

Particularly, the present invention relates to a method and system for translating content capable of performing translation tasks even for text that is not recognized in an episode of the content.

To solve the aforementioned objects, a method of translating content according to one embodiment of the present invention may include receiving an image file of a translation target related to an episode of content created based on a language of a first country, extracting text corresponding to the language of the first country from the image file, and providing a translation editor for the image file so that a translated episode of the episode is generated on the basis of a language of a second country different from the first country using the image file, wherein the translation editor may include a first area in which the image file of the translation target is output, and a second area for receiving a translated language in the language of the second country for the extracted text as input. In response to a control command for image capturing at least a portion of the output image file received through the first area, an input window for receiving a translated language for the captured image as input may be generated in the second area.

A system for translating content according to one aspect of the present invention may include a management server configured to register an image file of a translation target related to an episode of content created on the basis of a language of a first country, a translation server configured to receive the image file of the translation target, in which the translation server may provide a translation editor for the image file so that a translated episode of the episode is generated on the basis of a language of a second country different from the first country using the image file. The translation editor may include a first area in which the image file of the translation target is output, and a second area for receiving a translated language in the language of the second country for text extracted from the image file of the translation target as input. In response to a control command for image capturing at least a portion of the output image file received through the first area, an input window for receiving a translated language for the captured image as input may be generated in the second area.

There is provided a program stored on a computer-readable recording medium, and executed by one or more processes in an electronic device, according to another aspect of the present invention. The program may include instructions to allow the program to perform receiving an image file of a translation target related to an episode of content created based on a language of a first country, extracting text corresponding to the language of the first country from the image file, and providing a translation editor for the image file so that a translated episode of the episode is generated on the basis of a language of a second country different from the first country using the image file, in which the translation editor may include a first area in which the image file of the translation target is output, and a second area for receiving a translated language in the language of the second country for the extracted text as input, and in response to a control command for image capturing at least a portion of the output image file received through the first area, an input window for receiving a translated language for the captured image as input may be generated in the second area.

The method and system for operating content translation according to yet another aspect of the present invention provides a new form of translation editor and review editor, thereby implementing a translation environment in which translators, reviewers, and others can perform translations more accurately and efficiently.

Further, the method and system for translating content according to still another aspect of the present invention can extract text corresponding to the language of a first country from the image file of the translation target and provide a translation editor for the extracted text.

In this case, by further providing a process of image capturing at least a portion of an image file output on the translation editor to perform translation, an efficient translation task may be proceeded even for characters not extracted from the episode, such as dialogue, sound effects, character emotions, explanations, and more.

### BRIEF DESCRIPTION OF THE DRAWINGS

FIG. 1 is a diagram for describing a system for content translation according to the present invention.

FIG. 2A is a flowchart for describing a method of content translation according to the present invention.

FIG. 2B, FIG. 3A, and FIG. 3B are flowcharts for describing data flow according to the method of operating content translation of the present invention.

FIG. 4A, FIG. 4B, FIG. 4C, and FIG. 4D are diagrams for describing an operator account and a manager account according to the present invention.

FIG. 5 is a flowchart for describing a method of translating content in the system for content translation according to the present invention.

FIG. 6 is a diagram for describing episodes of content provided in the present invention.

FIG. 7A, FIG. 7B, FIG. 7C, and FIG. 7D are diagrams for describing a translation editor provided in the present invention.

FIG. 8A, FIG. 8B, and FIG. 8C are diagrams for describing a review editor provided in the present invention.

FIG. 9 is a diagram for describing a translation file according to the present invention.

FIGS. 10A and 10B are diagrams for describing a method of reviewing a lettered file in the present invention.

### DETAILED DESCRIPTION OF THE INVENTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The terms “module”, “unit”, “part”, and “portion” used to describe constituent elements in the following description are used together or interchangeably in order to facilitate the description, but the term themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be understood that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

The present invention relates to a method of content translation and a system therefor, which may provide a function interface necessary for translation, lettering, and review tasks of content, in linkage with content provision services, as well as a communication tool (e.g., Inbox, Message) between task operators.

The types of content to which the present invention may be applied may be highly diverse. For example, at least one type of content, such as webcomics, web novels, music, e-books, videos, or images, may correspond to the content provided in the present invention.

Hereinafter, for convenience of description, the content corresponding to a webcomic will be used as an example. Here, a webcomic refers to a combination of “web” and “comics,” meaning cartoons or comics provided through an Internet communication network.

Such content may be composed of a plurality of sub-content. A plurality of sub-content may make up a series of the content.

Here, a series may refer to sequentially planned works or content.

In the present specification, to avoid confusion between “content” and “sub-content,” the term “sub-content” will be referred to as “episode.”

In the present specification, “using (consuming or viewing) content” may be understood as using (consuming or viewing) an episode.

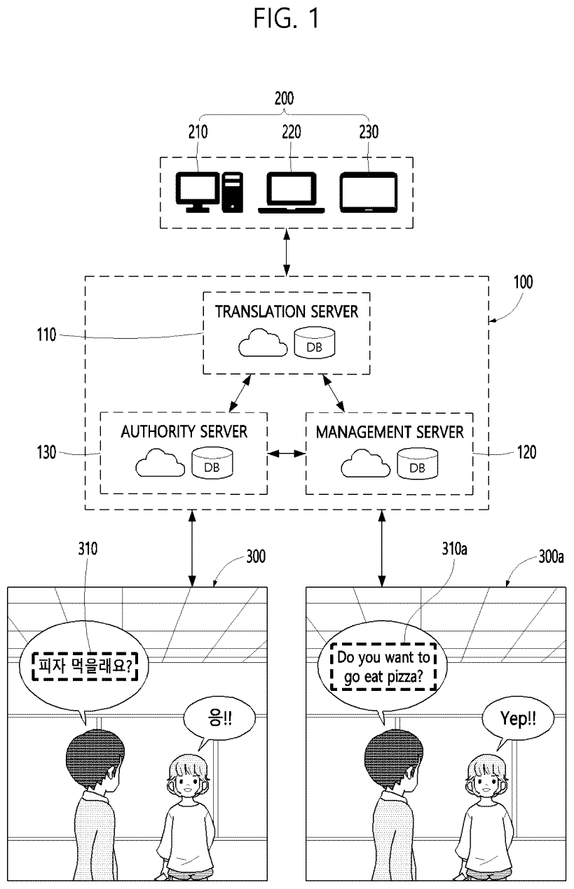

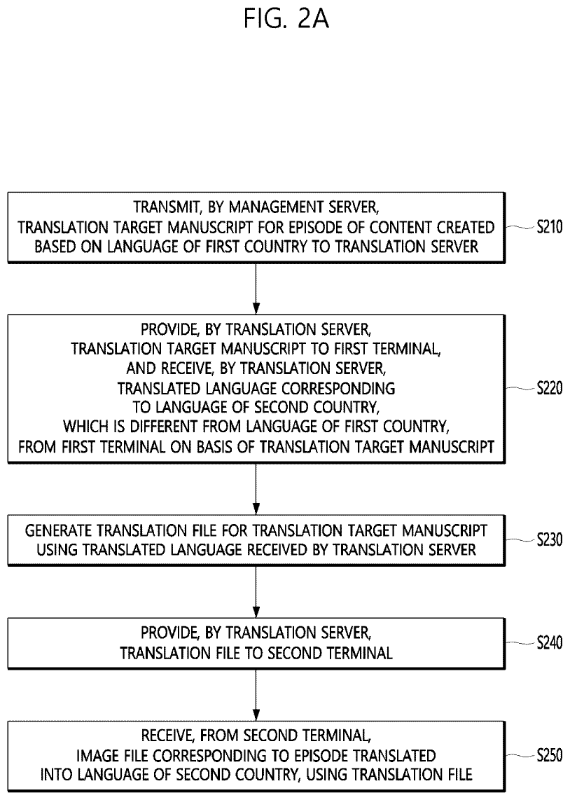

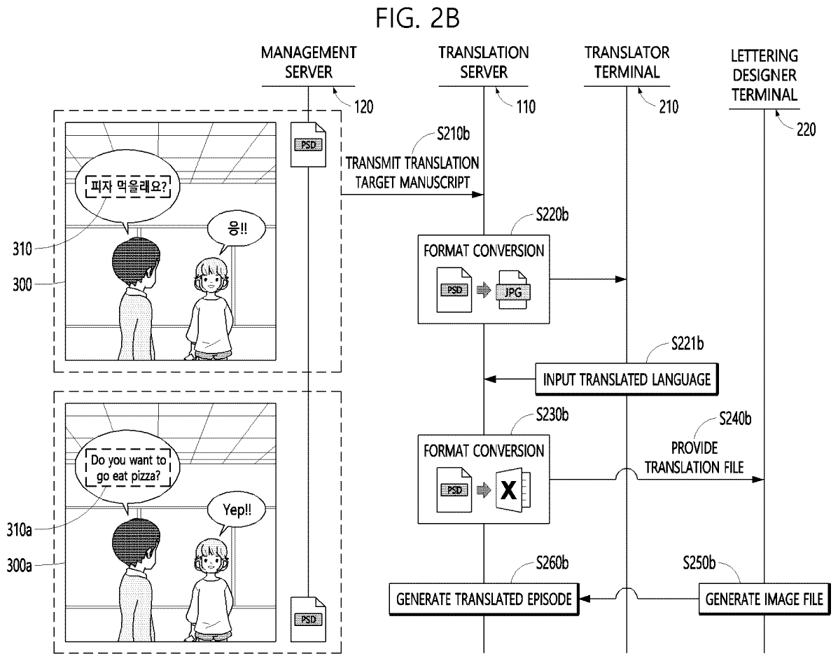

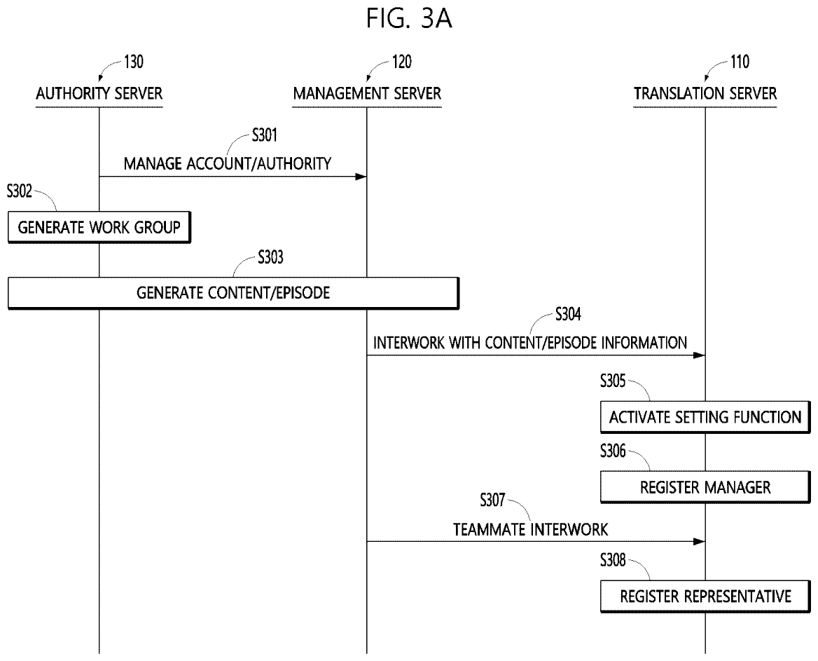

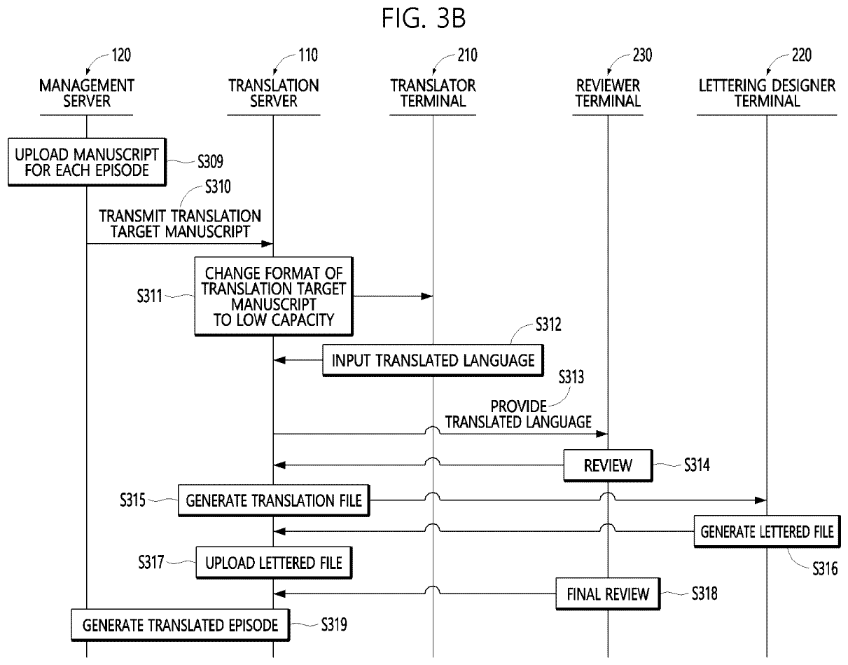

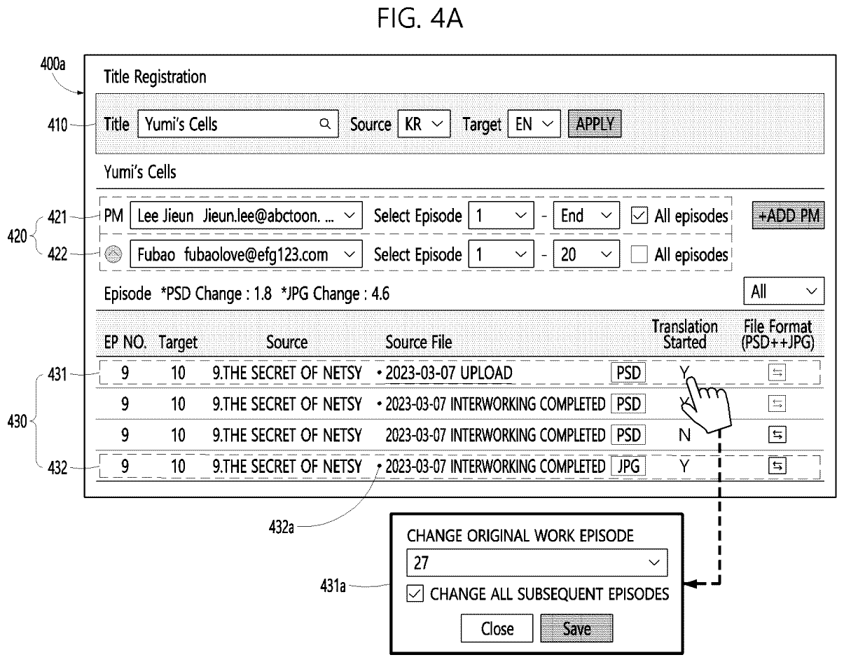

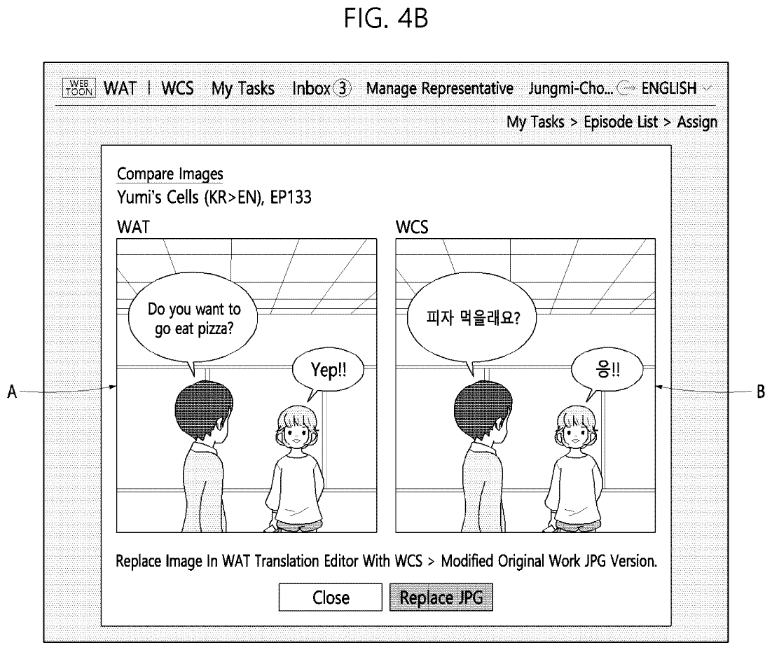

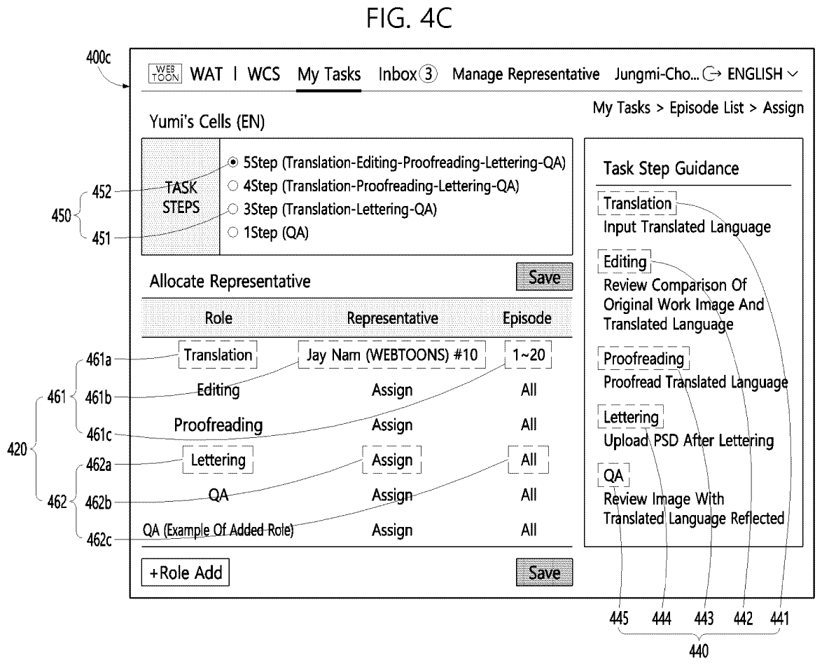

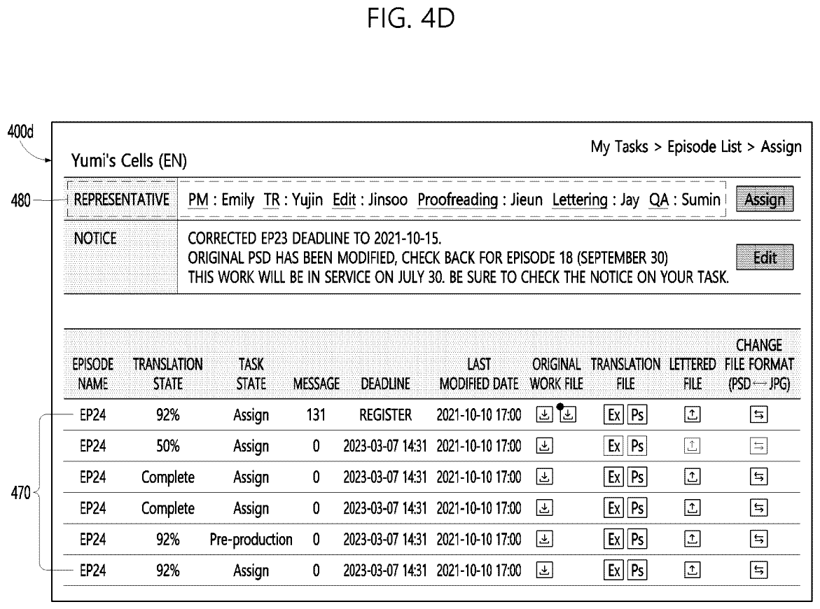

Hereinafter, a method of translating content will be specifically described with reference to the accompanying drawings. FIG. 1 is a diagram for describing a system for content translation according to the present invention. FIG. 2A is a flowchart for describing a method of operating content translation according to the present invention, FIG. 2B, FIG. 3A, and FIG. 3B are flowcharts for describing data flow according to the method of operating content translation of the present invention, and FIG. 4A, FIG. 4B, FIG. 4C, and FIG. 4D are diagrams for describing an operator account and a manager account according to the present invention.

As illustrated in FIG. 1, a system 100 for performing content translation may translate an episode 300 of content, which has been created based on the language of a first country (e.g., Korean, “ [symbol] ?”, 310), into the language of a second country that is different from the first country (e.g., English, “Do you want to go eat pizza?”, 310a).

Here, the “language of a first country” refers to a translation target language (original work language or source language), and the “language of a second country” may refer to the language of another country into which the language of the first country is translated (or target language).

The system 100 for operating content translation performs a task of translating the language of a first country (e.g., Korean, 310) included in a content episode into the language of a second country (e.g., English, 310a), as well as tasks of reviewing and lettering the translated language. In the present invention, this will be referred to as a “translation process” or a “translation review process.” However, this is merely an example for translation purposes, and the language of the second country may be any one of various languages, such as Japanese, Chinese, Spanish, Arabic, Indonesian, Thai, and others. Further, while the present invention provides an example of translating Korean into another country's language, it is also possible to translate another country's language into Korean or to translate between languages of different countries.

To provide such a translation process, the system 100 may include at least one of an authority server 130, a management server 120, and a translation server 110. The authority server 130, management server 120, and translation server 110 may be configured to transmit and receive various information related to content provision or content translation operations through wired or wireless communication. The transmission and reception of information may be performed by a communication unit 210 included in each server 110, 120, or 130.

Here, a server may be a computer system that provides information or services through a network. A server may be configured to exchange various information or data with other servers or user terminals. The authority server 130 may be configured to perform a role of managing authority for at least one of user accounts or content registered in the management server 120. The authority server 130 may receive a request for assigning authority or may assign authority on the basis of a specific condition being satisfied by a user account registered in the management server 120.

The authority server 130 may be configured to perform a role of managing authority for at least one user account or content registered in the management server 120. The authority server 130 may receive a request for assigning authority or may assign authority on the basis of a specific condition satisfied by a user account registered in the management server 120.

For example, the authority server 130 may assign an operator account, which holds the authority to operate the translation process, to a specific user on the basis of an operator account assignment request. As another example, the authority server 130 may register a specific user account, which is registered in the management server 120, as a manager who holds the authority to designate a representative for the translation process (e.g., translator, lettering designer, reviewer, etc.), on the basis of a request from an operator account.

The management server 120 may be configured to perform roles related to content provision and the management of content translation operations. The management server 120 may store original content (or original work content) received from an author, and on the basis of the original content, the management server 120 may provide the original content to the translation server 110 to carry out the translation process. In this case, the management server 120 manages user accounts and authority related to translation and performs the function of providing a source file of a translation target, as original content, to the translation server 110.

The system 100 may transform the file format of content episodes in various ways in the translation process and provide them to representatives.

For example, when an original episode image file received from the author is a high-capacity first type of file, the high-capacity file may be converted into a low-capacity second type of file and provided to the translation representative. As another example, when the original episode image file is the low-capacity second type of file, it is also possible to convert the low-capacity second type of file into the high-capacity first type of file.

The high-capacity first type of file may be, for example, a photoshop document (PSD) file, a Clip file (clip studio file), etc., while the low-capacity second type of file may be, for example, a JPG or PNG file, etc. However, the present invention is not limited to the examples of the first type and the second type of file, and they may be transformed into various forms. For example, as technology advances, other files may be applied to the high-capacity files presented as examples, in addition to PSD files or Clip files. In addition, as the low-capacity file, a different file may be applied as needed.

Further, in the present invention, to allow the lettering representative to intuitively recognize a translated language and a lettering task position, a third type of file in which a first language is matched with the translated language of the first language may be provided to a lettering designer. The third type of file may be, for example, a document file. The document file may be, for example, an Excel file or a Word file, and may be transformed into various forms. Hereinafter, a case where the third type of file is an Excel file will be described as an example.

The management server 120 may manage various types of files generated in the translation process by mapping (or matching) the various types of files to each other, with respect to original content episodes. Such mapped information may be used to review whether the translation is correct by comparing a translated output with the original content.

The translation server 110 may perform the role of providing a customized environment to each representative so that the translation process, from the setting of representatives of the translation process to translation, lettering, and review tasks, may be performed.

The translation server 110 may set task steps (or task processes) and task representatives for the translation process of a specific episode through the designation by an operator account or a manager account.

In the present invention, tasks included in the translation process may include at least one of i) a translation (or inputting translated language), ii) an editing review in which a translated language is modified and input, iii) a proofreading review, which uses messages on the translated language to provide feedback, iv) lettering, which changes the characters of an original content episode into the translated language, or v) an image review (lettered file review, final review, or QA review), which verifies an image reflecting the translated language.

In the operator account or manager account, representatives for the translation process of a content episode may be designated on a task-by-task basis (a task-unit basis) (e.g., translation task-‘representative A’, lettering task-‘representative B’), while deadlines may be designated on an episode basis.

The translation server 110 may provide a translation editor (a translation tool that allows each task included in the translation process proceed) to a terminal 200 of a translation process representative (or representative account or user account of the representative). Such a translation editor may provide translation support tools (e.g., memory, glossary) as well as features (image review, file format conversion, inbox messages, feedback, image comparison function, and the uploading of translated episodes after the completion of lettering tasks).

The system 100 for operating content translation according to the present invention may be connected to at least one terminal 200 via wired or wireless communication. As illustrated in FIG. 1, the terminal 200 refers to an electronic device, and may be a smartphone, notebook computer, laptop computer, slate PC, tablet PC, ultrabook, desktop computer, and the like, without limitation on types. The service provided in the present invention may be used through the terminal 200 logged in with a user account registered on the management server 120. For example, a translator responsible for the translation of an episode may be provided with a translation editor through a terminal 210 (which also may be referred to as a translator terminal) logged in with his or her user account, and may proceed with a task of translating the language of a first country included in the episode into the language of a second country using various functions provided in the translation editor. As another example, a lettering representative (lettering designer), responsible for lettering (sketching, drawing, or designing) a translated language into an episode, may be provided with a translation file using a terminal 220 (which also may be referred to as a lettering designer terminal) logged in with his or her user account. Accordingly, in the present invention, “user,” “representative (e.g., translator),” “user account (e.g., translator account),” and “terminal (e.g., translator terminal)” may be used interchangeably.

Meanwhile, as illustrated in FIG. 2A, a process of transmitting a translation target manuscript for an episode of content created based on the language of the first country from the management server to the translation server begins (S210).

As described above, the original content (or original work content) may be stored in the management server 120, and on the basis of at least one episode of the original content designated as a translation target, the management server 120 may provide a file of the specified episode as a translation target manuscript to the translation server 110.

In this case, the management server 120 may transmit a first type of file (e.g., PSD, Clip, etc.) including a plurality of layers to the translation server 110 (S210b, see FIG. 2B).

The first type of file may have layers separated by different elements (e.g., background, character, text, speech bubbles, etc.), and the management server 120 may provide the first type of file to the translation server 110 so that changing the language of the first country to the language of the second country may be done more easily.

In the present invention, a process in which the translation server provides a translation target manuscript to a first terminal and receives, from the first terminal, a translated language corresponding to the language of a second country, which is different from the language of a first country, on the basis of the translation target manuscript, may proceed (S220, see FIG. 2A).

The translation server 110 may identify a translation representative of a translation target manuscript and provide the translation target manuscript to the first terminal 210 (translator terminal) logged in with a translation representative account.

Matching information on translation process representatives (e.g., translation representative, lettering design representative, etc.) for a specific episode may exist in the database (DB) of the translation server 110, A representative may be designated by a manager, and the translation server 110 may refer to the database (DB) to provide information necessary for tasks to representatives corresponding to the process in which the translation is being carried out. The details regarding the designation of a representative by a manager will be described below.

The translation server 110 may convert the first type of translation target manuscript into a second type of file, which is different from the first type, and provide the second type of file to the first terminal 210 (translator terminal) (S220b, see FIG. 2B).

As such an example, the translation server 110 is configured to allow a file format to be changed in the operator account and manager account, depending on a file format type obtainable from a content writer or on a file format type that is more suitable for translation. Hereinafter, an example will be given of a process of converting a high-capacity file of a first type into a low-capacity file of a second type. However, this is merely an example, and it is also possible to convert a low-capacity file into a high-capacity file as needed. In such a case, the management server transmits the second type of translation target manuscript to the translation server, and the translation server may convert the second type of translation target manuscript into the first type of file, which is different from the second type, and provide the converted first type of file to the first terminal.

Additionally, as described above, the first type of file may be, for example, a photoshop document (PSD) file, a Clip file (clip studio file), etc., and this may be substituted with various other types of files. In addition, the low-capacity second type of file may be, for example, a JPG or PNG file, but this may also be substituted with various other types of files.

The first type of file (e.g., PSD, Clip, etc.) is composed of a plurality of layers, which makes it easy to be modified, but may be a high-capacity file. Since the translation representative is not responsible for carrying out modification tasks on the translation target manuscript, the high-capacity first type of file is not needed. Therefore, the translation server 110 may convert the translation target manuscript from the first type of file into the second type of file with a smaller capacity than the first type, and provide the converted second type of file to the first terminal 210 (translator terminal) for efficient data communication.

The translation server 110 may provide the first terminal 210 (translator terminal) with a translation editor that includes the translation target manuscript converted into the second type of file. As described above, the translation editor is an interface for an efficient task environment for representatives, and further details will be described below.

On the first terminal 210 (translator terminal), the translation target manuscript converted into the second type of file is displayed, and a translated language (e.g., “Do you want to go eat pizza?”, 310a) corresponding to the language of the first country included in the translation target manuscript (e.g., “ [symbol] ”, 310) may be input. The translation server 110 may receive the translated language on the basis of the translated language input into the first terminal 210 (translator terminal) (S221b, see FIG. 2B).

Further, in the present invention, a process of generating a translation file for the translation target manuscript using the translated language received by the translation server may proceed (S230, see FIG. 2A).

The translation server 110 may generate a translation file for the translation target manuscript using the translated language received from the first terminal 210 (translator terminal).

In the present specification, the “translation file” may refer to a file provided to the lettering design representative responsible for a lettering task of the translated language.

A lettering designer, on the basis of the translation file, may be responsible for a task of changing the language of the first country to the language of the second country on a character layer among the plurality of layers in the translation target manuscript. The lettering designer needs to input (create, design, or sketch) the translated language in an area where the language of the first country was positioned, and it is very helpful for the lettering designer to intuitively recognize a matching relationship between the language of the first country and the language of the second country, which is the translated language.

The translation server 110 may generate a translation file in which the language of the first country and the translated language of the second country are each matched, so that the lettering designer may intuitively recognize the language of the first country and the translated language corresponding to the language of the first country (see FIG. 4D).

In this case, the translation server 110 may generate the translation file as at least one of a first type of file (e.g., PSD, Clip, etc.) or a third type of file (e.g., Excel) (S230b, see FIG. 2B). That is, the translation server 110 may set different formats of image files for the first terminal 210 (translator terminal) and the second terminal 220 (lettering designer terminal), and provide the translation target manuscript accordingly. Therefore, representatives may be provided with files in a format optimized for their tasks.

Further, the translation server may provide the translation file to the second terminal (S240, see FIG. 2A).

The translation server 110 may identify a responsible lettering designer for the translation target manuscript by referring to the database (DB), on the basis of the process in which the translation is being carried out corresponding to a lettering process. The translation server 110 may transmit the translation file to the second terminal 220 (lettering designer terminal) logged in with the account of the responsible lettering designer. For example, the translation server 110 may provide both the first type of translation file (e.g., PSD, Clip, etc.) and the third type of translation file (e.g., Excel) to the second terminal 220 (lettering designer terminal) (S240b, see FIG. 2B), and the lettering designer may proceed with the lettering task by selecting a desired type of translation file between the first type and the third type.

Meanwhile, the translation process further includes a “review” task process, and a review task may further include an editing review and a proofreading review performed between the translation task and the lettering task, as well as an image review performed after the lettering task. Further details regarding the entire process, including the review process, will be described below.

A process of receiving an image file corresponding to the episode, translated into the language of the second country using the translation file, from the second terminal may then proceed (S250, see FIG. 2).

The translation server 110 may provide the second terminal 220 (lettering designer terminal) with the translation file and the first type of translation target manuscript file.

In the second terminal 220 (lettering designer terminal), on the basis of the translation file, the task of changing the characters of the language of the first country included in a character layer among the plurality of layers that make up the translation target manuscript file to the translated language, which is the language of the second country may be carried out. In the second terminal 220 (lettering designer terminal), an image file including the language of the second country may be generated (S250b), and the translation server 110 may receive the image file.

In the image file received from the lettering designer terminal 220, the characters of the episode have been changed to the language of the second country, which is different from the first country, and this may be referred to as a “lettered file.” In the translation server 110, a translated episode for the content episode may be generated using the lettered file (S260b, see FIG. 2B).

Meanwhile, the system 100 may operate a translation platform in linkage with the authority server 130, management server 120, and translation server 110 to specify content works that require translation, set translation, lettering, and review representatives for the specified content, and ensure that tasks are carried out by the representatives according to the order of the tasks. Hereinafter, the entire translation process that proceeds in the present invention, from specifying the work to reviewing, will be described.

As illustrated in FIG. 3A, the authority server 130 may manage user accounts and authorities (S301). The authority server 130 may assign an operator account, which holds the operation authority for the translation process, to a specific user on the basis of an operator account assignment request.

In the present specification, an “operator (or operator account)” may have authority over at least one of several designating managers, managing the translation target manuscript, managing translation process representatives, and managing translation support tools (e.g., glossary).

In the authority server 130, a work group may be generated (S302, see FIG. 3A). Further, on the basis of the work group being generated in the authority server 130, at least one of the authority server 130 or the management server 110 may generate content and episodes based on the work group (S303, see FIG. 3A). Work groups, content, and episodes may be generated in sequence, and on the basis of the content and episodes being generated, information on the content and episodes may be linked to the translation server 110 (S304, see FIG. 3A).

Information on the content and episodes may vary widely. As described above, the content may be made up of a plurality of episodes, and episode information according to a predefined order (e.g., upload order) may exist to be matched with the plurality of episodes. For example, the plurality of episodes that make up a specific content titled “Yumi's Cells” may have episode information matched according to the upload order, such as Episode 1 (ep. 1), Episode 2 (ep. 2), and Episode 3 (ep. 3). Various types of information, such as content (e.g., content title information), episodes making up the content (e.g., episode files), and episode numbers, are matched with each other. In the management server 120 and translation server 110, the information on the content and episodes may continuously be linked and updated.

Meanwhile, when the content and episodes are generated in the management server 120, a setting function (or title registration function) for registering the translation target content may be activated in the translation server 110 (S305, see FIG. 3A).

As illustrated in FIG. 4A, a service page 400a provided to the operator account may include translation target content and a setting function (or setting function area 410) for setting the types of languages for the first country and the second country for the translation target content. The translation server 110, through the setting function 410, may receive content title information (e.g., “Yumi's Cells,” 411), information on the type of language for the first country for the content (or original work language code, e.g., KR, 412), and information on the type of language for the second country (or translated work language code, e.g., EN, 413). The translation server 110 may specify translation target content (e.g., “True Beauty”) and the first country language and second country language of the translation target content on the basis of the information received through the setting function 410.

The operator account includes the authority to register managers, and in the translation server 110, on the basis of receiving a manager registration request for a specific user account from the operator account, the specific user account may be registered as a manager (S306, see FIG. 3A).

In the present invention, the manager may set task processes and task representatives for the translation process of an episode.

As illustrated in FIG. 4A, the translation server 110 may receive a manager registration request, including information 420 on a specific user account, from the operator account through the service page 400a. The manager registration request may include the manager's name. In addition, in case that the registration of a plurality of managers is requested for a single content, the manager registration request may include information in which the names of each of the plurality of managers are matched with episodes that managers are responsible for.

The translation server 110 may register the task processes and task representatives for the translation process of an episode by setting the task processes and task representatives through either the operator account or the manager account (S308, see FIG. 3A).

In the present invention, depending on whether the task representative registration is carried out by the operator account or the manager account, the management server 120 and the translation server 110 may proceed with interworking between user accounts (Teammate interwork) (S307, see FIG. 3A).

In the management server 120 and the translation server 110, when a representative registration request is received from the operator account, the requested user may be registered as a representative without the user account interworking process. In contrast, in the management server 120 and the translation server 110, the registration of a representative may proceed only for user accounts that are interworked with the manager account. The management server 120 and the translation server 110 may proceed with the registration of a representative only after interworking with the user account through a Teammate invitation when the manager account and the corresponding user account are not already in an interwork relationship.

Hereinafter, for convenience of description, an example will be provided in which the representative registration is carried out by the manager account, and user account interworking between the manager and the representative has been completed.

In the present invention, the translation process may include at least one of a plurality of task processes, and the translation server 110 may provide a translation task interface corresponding to a task process to the representative terminal of the task process.

As illustrated in FIG. 4C, the task process (or task step, 440) included in the translation process in the present invention may include at least one of i) translation (or inputting translated language, Translation, 441), ii) an editing review (Editing, 442) in which the translated language is modified and input, iii) a proofreading review (Proofreading, 443) which uses messages on the translated language to provide feedback, iv) lettering (Lettering, 444), which changes the characters of the original content episode into the translated language, or v) an image review (QA, 445), which verifies an image reflecting the translated language.

The translation server 110 may configure the translation process to allow at least one of the plurality of task processes 441 to 445 to be included by the manager account. In the manager account, the translation process may be configured in various ways based on episodes, translation companies and other factors. For example, as illustrated in FIG. 4C, the translation server 110 may configure the process to include only translation, lettering, and image review tasks (Translation-Lettering-QA, 451), or configure the process to include all tasks such as translation, editing review, proofreading review, lettering, and image review (Translation-Editing-Proofreading-Lettering-QA, 452).

The translation server 110 may specify the representative for the task process on the basis of the task process for the episode of the content being specified. The translation server 110 may match the task process (e.g., Translation, 461a), the representative (user account, 461b), and the assigned episode (episodes 1-20, 461c), and store them in the database as a representative dataset 461. The translation server 110 may configure a representative dataset 461 or 462 for each task process of an episode on the basis of the information received from the manager account and store the representative dataset in the database. Further, in the process in which the translation is being carried out for an episode, the translation server 110 may refer to the database to identify the representative for the current task process.

As illustrated in FIG. 4C, the manager account may be provided with a management page 400d related to managing the translation process of an episode. The manager may perform overall task management of the translation process, management for the representatives, and management for deadlines through the management page 400d. To this end, the management page 400d may include a list of translation target content 470 allocated to the manager account, information on each representative for the task processes of the translation process 480, information on the task progress status for each episode, a deadline setting function, functions for registering and modifying notices, and a file upload function, and the like.

Meanwhile, in the management server 120, the upload of the translation target manuscripts for each episode of the content may be carried out (S309, see FIG. 3B). For example, the management server 120 may receive a translation target manuscript from a writer account (or writer terminal) that creates the content episodes and upload the translation target manuscript to the database of the management server 120. As another example, the management server 120 may receive a translation target manuscript from a content upload representative account (or representative terminal) and upload the translation target manuscript to the database of the management server 120. In the present invention, The method by which the translation target manuscript is uploaded to the management server 120 may vary.

The management server 120 may transmit the translation target manuscript to the translation server 110 to proceed with the translation process for the translation target manuscript, in linkage with the translation server 110 (S310, see FIG. 3B).

In this case, the translation server 110 may change a file format of the translation target manuscript provided to the first terminal 210 (translator terminal) to a different format type. Such a file format may be converted by the operator account or the manager account as a more suitable type for translation.

For example, the translation server 110 may proceed with the task of converting the translation target manuscript received from the management server 120 into a low-capacity format (S311, see FIG. 3B). However, in this example, converting to a low-capacity format is merely an example, and it is also possible to convert to a high-capacity format as needed, or to make changes regardless of the file capacity on the basis of the translator's opinion or the like.

As described above, content episodes may be configured as a first type of file that includes a plurality of layers. The first type of file may have layers separated by different elements (e.g., background, character, text, speech bubbles, etc.), and the management server 120 may provide the first type of file to the translation server 110 so that changing the language of the first country to the language of the second country may be done more easily. The first type of file is composed of a plurality of layers, which makes it easy to be modified, but it may be a high-capacity file. Since the translation representative is not responsible for carrying out modification tasks on the translation target manuscript, the high-capacity first type of file is not needed. Therefore, the translation server 110 may convert the translation target manuscript from the first type of file into the second type of file with a smaller capacity than the first type, and provide the converted second type of file to the first terminal 210 (translator terminal) for efficient data communication.

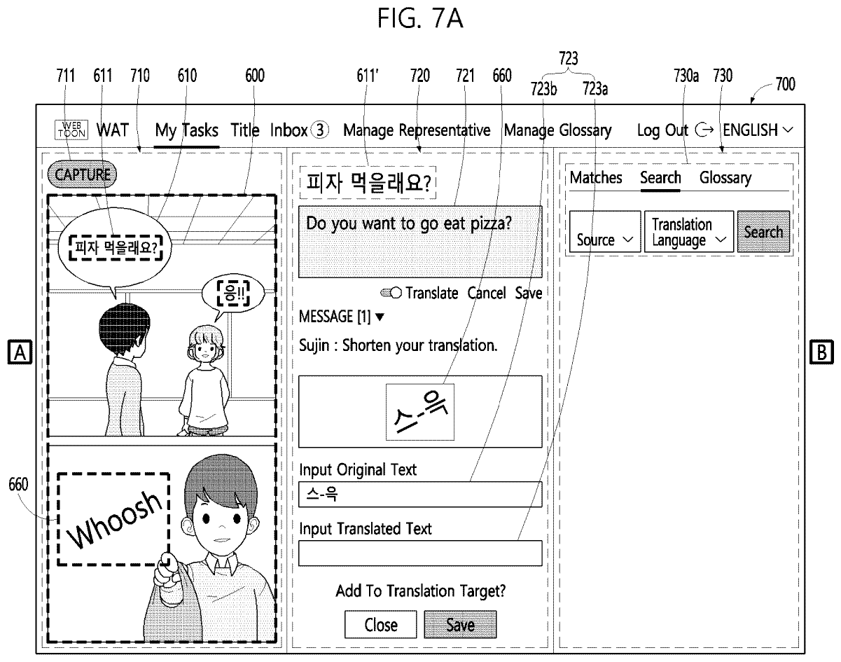

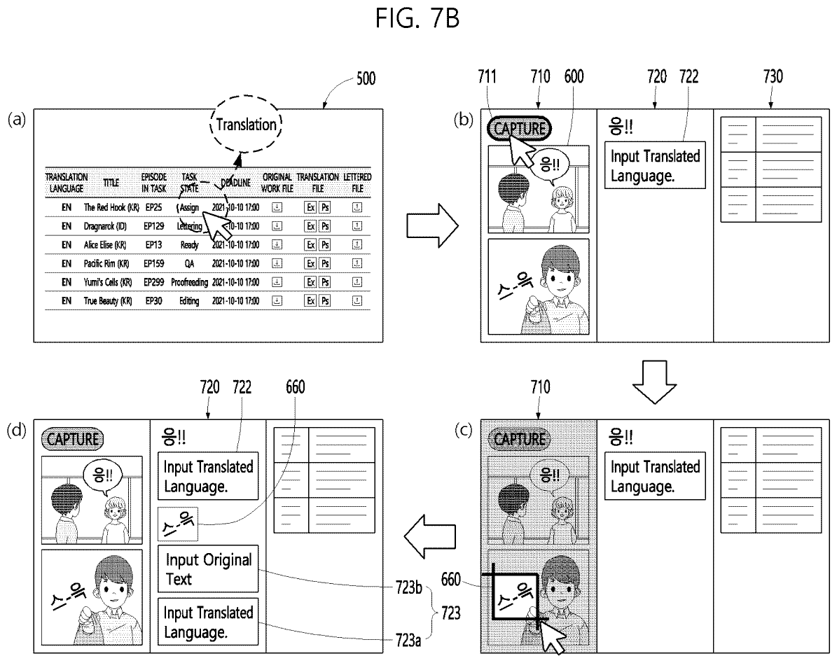

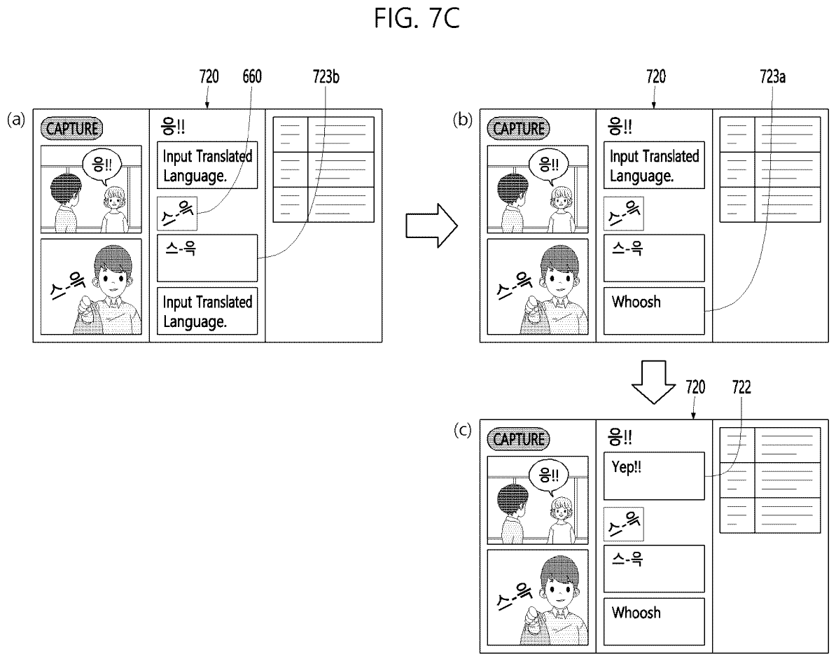

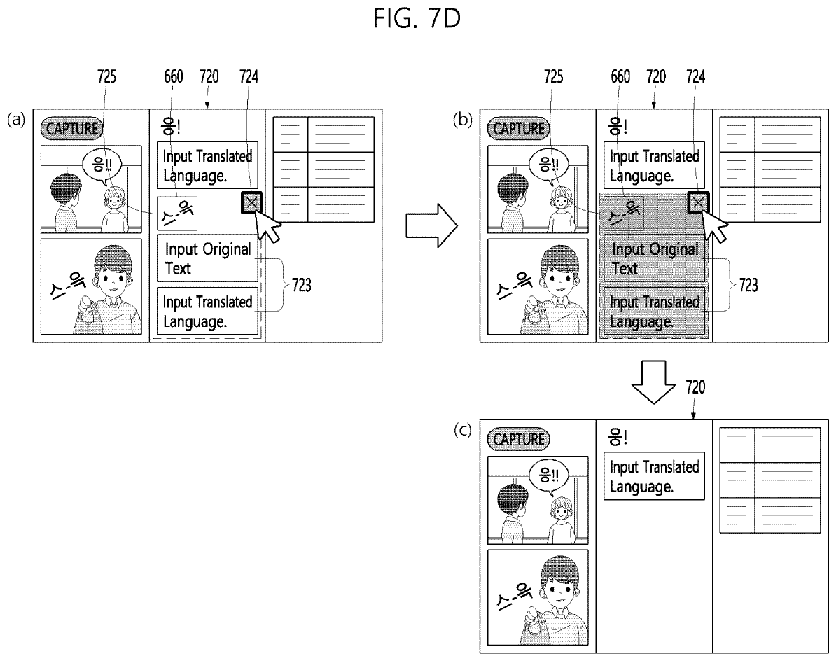

Further, in the translator terminal (first terminal, 210), the translated language corresponding to the language of the first country included in the translation target manuscript may be input (S312, see FIG. 3B). The translation server 110 may provide the translator terminal 210 with a translation editor (see reference numeral “700” in FIG. 7A) that includes a translated language input function. The translation editor 700 may include an input window capable of translated language input.

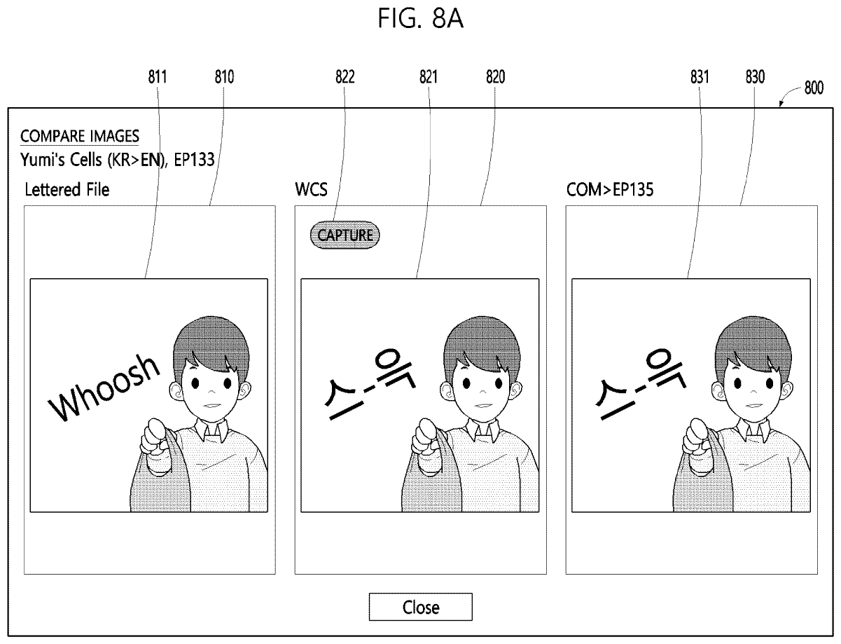

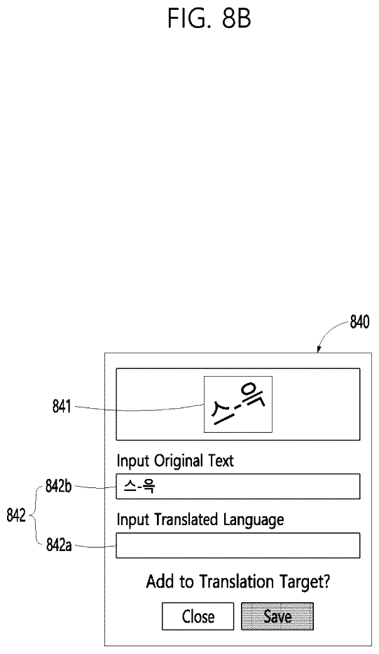

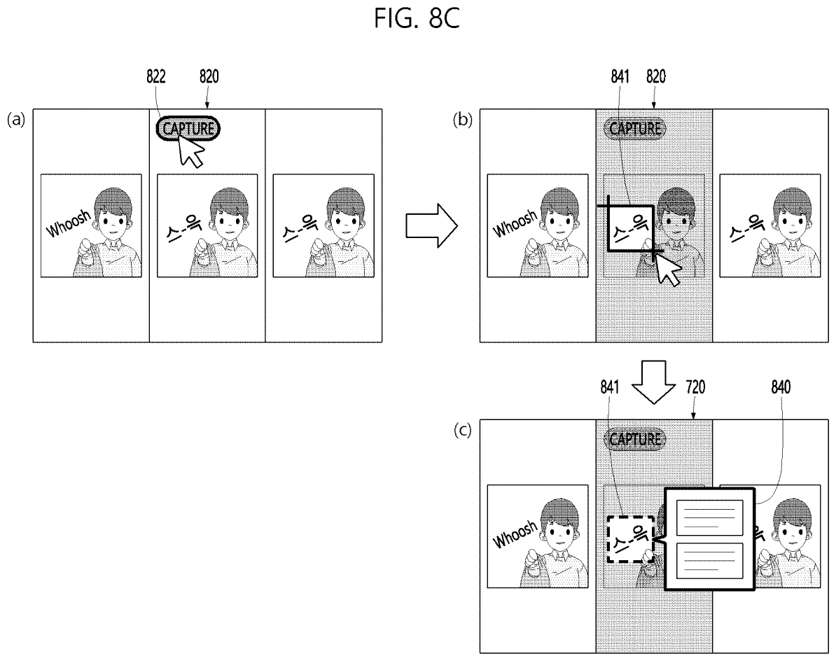

The translation server 110 may provide the reviewer terminal 230 with a review editor (see reference numeral “800” in FIG. 8A) that includes the translated language, so that a review on the translated language may be conducted (S313, see FIG. 3B). More specifically, the translation server 110 may provide the reviewer terminal 230 with an original image corresponding to the translation target manuscript and an image converted into the translated language, so that a review on the translated language received from the terminal of the translation representative may be performed.

As described above, the review process for reviewing the translated language may include an “editing review” that modifies and inputs the translated language, a “proofreading review” that uses messages on the translated language to provide feedback, and an “image review (or QA review)” that needs to perform a review of the lettered file. In the current process, the review task process being described may correspond to an “editing review task” that modifies and inputs the translated language.

The reviewer terminal 230 may compare the original image with the image displaying the translated language and perform an editing review by modifying the translated language (S314, see FIG. 3B).

Further, a proofreading review task, which uses messages on the translated language to deliver feedback to the translation representative, may proceed. A proofreading review representative may be the same user as an editing review representative or a different user. The translation server 110 may transmit a message to the translator terminal on the basis of receiving the message including feedback information on the translated language from a proofreading reviewer terminal. The translation server 110 may display the feedback information received from the proofreading reviewer terminal in one area of the translation editor 700. In this case, the translation server 110 may display the feedback information in the area surrounding the translated language (e.g., “Do you want to go eat pizza?”) that is the subject of the feedback.

The translation server 110 may generate a translation file for the translation target manuscript on the basis of the review of the translated language being completed (S315, see FIG. 3B).

In the present invention, the “translation file” may refer to a file provided to the lettering design representative responsible for a lettering task of the translated language.

The translation server 110 may generate the translation file as at least one of a first type of file or a third type of file. The lettering designer needs to input (create, design, or sketch) the translated language in an area where the language of the first country was positioned, and the lettering designer should intuitively recognize a matching relationship between the language of the first country and the language of the second country, which is the translated language. Accordingly, in the present invention, the translation file may be generated as a third type of file having a table structure and provided to the lettering designer.

In the second terminal (lettering designer terminal, 220), a lettered file may be generated using the translation file (S316, see FIG. 3B). In the second terminal 220 (lettering designer terminal), on the basis of the translation file, a task may be performed where the characters of the language of the first country, included in the character layer among the plurality of layers that make up the translation target manuscript file, is changed to the translated language, which is the language of the second country. The lettering designer terminal 220 may transmit and upload the lettered file to the translation server 110 (S317, see FIG. 3B). The lettered file may be configured of a first type of file consisting of a plurality of layers.

The translation server 110, upon the upload of the lettered file, may allow a final review of the lettered file to be conducted on the reviewer terminal 230 of the image review representative (S318, see FIG. 3B). Although FIG. 3B illustrates the reviewer terminal for the editing review, proofreading review, and image review (or final review) collectively as “reviewer terminal 230” without distinction, the representatives for the editing review, proofreading review, and image review (or final review) may be different, in which case, the reviewer terminals may also differ.

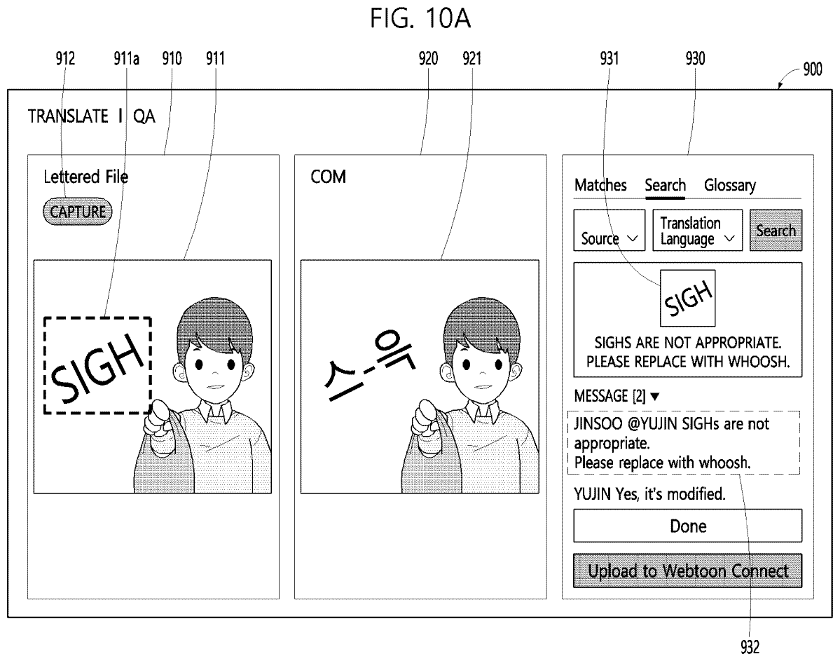

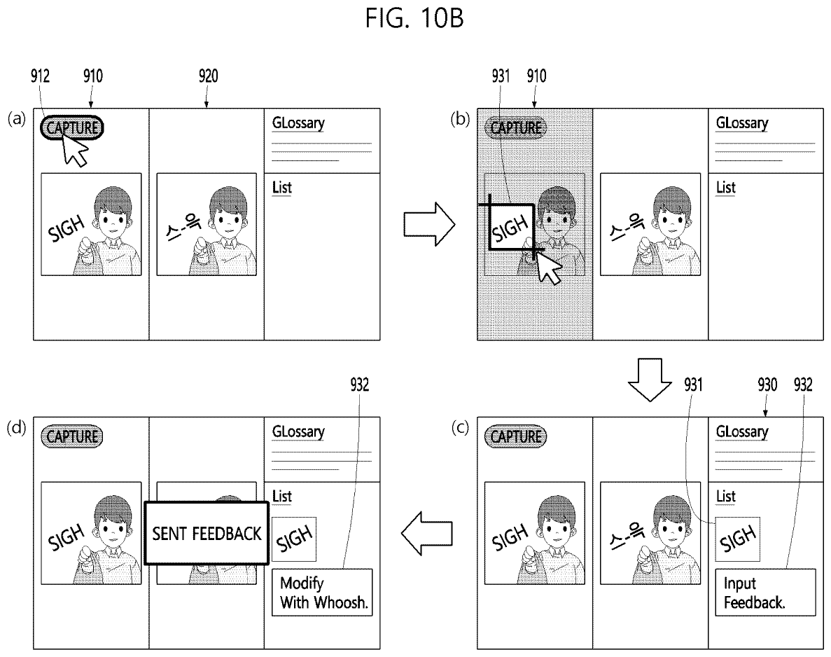

The translation server 110 may provide the image reviewer terminal 230 with a QA editor (see reference numeral “900” in FIG. 10A) so that a final review of the translated episode converted into the translated language may be conducted. The QA editor 900 may include an image file of the episode created based on the language of the first country (original image file or image file of the translation target manuscript) and the lettered file converted into the language of the second country (or translated episode image file). The image reviewer terminal 230 may compare the images of the files output in the QA editor 900 and proceed with the final review of the translated episode (S318, see FIG. 3B).

On the basis of the final review of the translated episode having been completed, the translation server 110 and the management server 120 may generate a translated episode corresponding to the episode created based on the language of the first country by using the lettered file created based on the language of the second country (S319, see FIG. 3B).

As described above, the system 100 for performing content translation may provide content translation representatives with the necessary information and user environment for translation tasks, on the basis of interworking of the authority server 130, management server 120, and translation server 110. The representatives may easily proceed with content translation tasks using the task environment provided by the system 100 for operating content translation. Accordingly, the “system for performing content translation” may also be referred to as a “content translation platform” or a “content translation system.”

In addition, in order to provide the content translation representative with a user environment optimized for translation tasks, the present invention illustrates a new form of translation editor and review editor.

Hereinafter, a more detailed description will be provided on a method of translating content based on capture in the present invention.

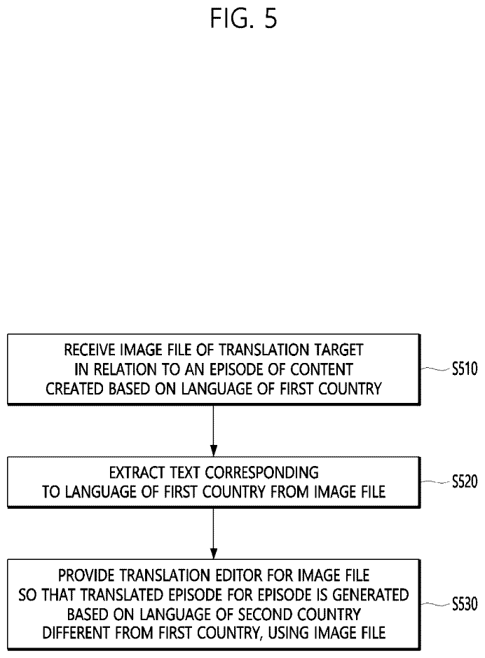

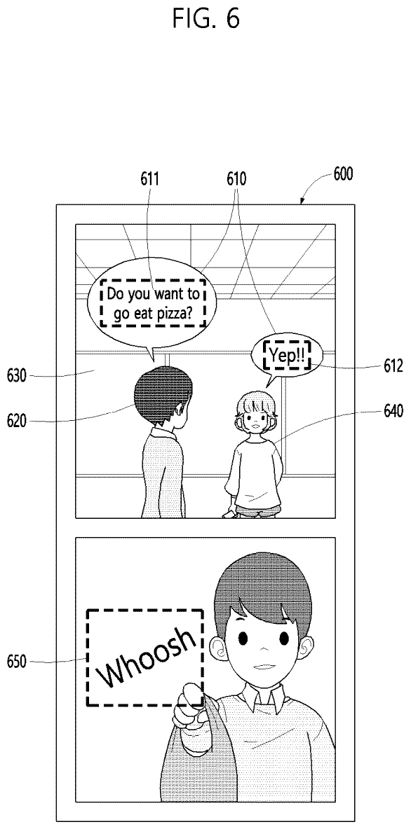

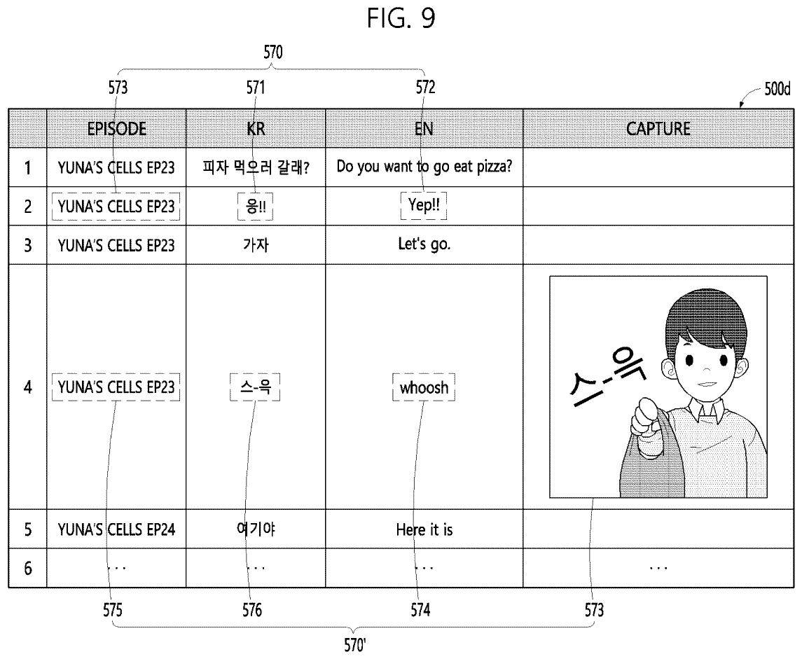

FIG. 5 is a flowchart for describing a method of translating content in the system for performing content translation according to the present specification, FIG. 6 is a diagram for describing episodes of content, FIG. 7A, FIG. 7B, FIG. 7C, and FIG. 7D are diagrams for describing a translation editor, FIG. 8A, FIG. 8B, and FIG. 8C are diagrams for describing a review editor, FIG. 9 is a diagram for describing a translation file, and FIGS. 10A and 10B are diagrams for describing a method of reviewing a lettered file.

With reference to an episode of content created based on the language of the first country, a process of receiving an image file of a translation target may proceed (S510, see FIG. 5).

The translation server 110 may receive an image file of an episode, which is a translation target, from the management server 120.

In the management server 120, episodes of specific content created based on the language of the first country (“source language,” “original work language,” or “translation target language”) may be registered and present. The management server 120 may register and manage the image files of episodes in a database, and provide the image files to the translation server 110 on the basis of being specified as translation targets.

In the present invention, a process of extracting text corresponding to the language of the first country from the image file may proceed (S520, see FIG. 5).

The translation server 110 may use various algorithms trained to recognize and detect text (or characters) included in an image to extract at least one text included in the image file of an translation target episode.

For example, as illustrated in FIG. 6, the translation server 110 may, through an optical character reader (OCR), extract text (e.g., “ [symbol] ?”, “ [symbol] ”, 611, 612) corresponding to the language of the first country (e.g., “Korean”) from an image file 600 of a translation target episode.

The translation server 110, when extracting text included in the image file 600 of the translation target episode through the optical character reader (OCR), may also extract position information on the text.

Here, “position information on the text” may be understood as information regarding where the text is positioned within the image file 600 of the translation target episode. As such an example, coordinate information on the extracted text within the entire image of the episode may be stored as the position information.

The translation server 110 may extract the text 611 and 612 corresponding to the language of the first country and the position information on the text from the translation target episode image file 600 through the optical character reader (OCR). The text and the position information are matched with each other by the translation server 110, and configured as a paired data set.

Meanwhile, the translation server 110 may extract the text corresponding to preset criteria from the image file 600 of the translation target episode into the translation target language. In the present invention, the image file 600 of the translation target episode may include a plurality of graphic objects 610 to 640. The translation server 110 may extract, as the translation target language, text 611 and 612 included in a specific graphic object (e.g., speech bubble graphic object, 610) among the plurality of graphic objects 610 to 640 included in the image file 600 of the translation target episode, which corresponds to the preset criteria.

More specifically, the translation server 110 may primarily identify the speech bubble graphic object 610 within the image file 600 of the translation target episode, and then, secondarily, extract the text 611 and 612 included in the speech bubble graphic object 610, along with position information on the text, through the optical character reader (OCR). The translation server 110 may extract position information on text layers for the extracted text 611 and 612 from the image file 600 of the translation target episode. Hereinafter, for convenience of description, the image file of the translation target episode will be interchangeably described as the “translation target image file” or “translation target image.”

A process may proceed to provide a translation editor for the image file so that a translated episode of the episode is generated based on the language of the second country, which differs from the language of the first country, using the image file (S530, see FIG. 5).

The translation server 110 may provide the translator terminal with a translation editor for the translation representative using an episode image file that is a translation target, along with text extracted from the image file and position information on the text.

As illustrated in FIG. 7A, the translation editor 700 may have a screen configured of a plurality of areas 710, 720 and 730, each displaying different information. Among the plurality of areas, in the first area 710 the translation target image file 600 may be output, while in the second area 720, an input window 721 may be output for receiving a translated text of the text (e.g., “ [symbol] ?” 611) extracted from the translation target image file 600 as input. In this case, to allow the translation representative to intuitively recognize which text among the plurality of texts included in the translation target image file 600 is currently being worked on for translation, a specific text (e.g., “ [symbol] ?” 611′) may be output around the input window 721 that is matched to the specific text.

Further, in the third area 730, at least one translation support tool 730a may be output to support the translation task of the translation representative. The translation support tool 730a may include various functions to support the translation task. For example, the translation support tool 730a may include a glossary (or dictionary, or translated language recommendation tool, etc.) that recommends translated language on the basis of a database of the languages of the first country and the second country.

The first area to the third area 710 to 730 of the translation editor 700 may be configured so that the translation representative of the translation editor 700, while identifying the translation target image file 600, may input the translated language and easily use the translation support tool 730a as needed. For example, the translation editor 700 may be configured so that the translation target image file 600 and the translation support tool 730a are output on both side of the input window 721, with the first area 710, the second area 720, and the third area 730 of the translation editor 700 being sequentially disposed along one direction (e.g., from direction A to direction B).

Meanwhile, by further providing a process of image capturing at least a portion of an image file output on the translation editor to perform translation, an efficient translation environment may be provided even for characters not extracted from the episode, such as dialogue, sound effects, character emotions, explanations, and more. Hereinafter, a more detailed description will be provided on the process of performing translation using this image capture.

As illustrated in FIG. 6, at least a portion of the image file 600 of the translation target episode according to the present invention may include characters (e.g., “ [symbol] ”, 650) that is not included in the speech bubble graphic object 610.

In the present invention, the characters (e.g., “ [symbol] ?,” “ [symbol] ,” 611, 612) disposed inside the speech bubble graphic object 610 may have a “dialogue” attribute of a person in the episode.

In contrast, the characters (e.g., “ [symbol] ” 650) disposed outside the speech bubble graphic object 610 may have attributes such as description, sound effects, or background of the episode.

Hereinafter, to avoid confusion of terms, the characters 611 and 612 disposed inside the speech bubble graphic object 610 will be referred to as “text,” while the characters 650 disposed outside the speech bubble graphic object 610 will be referred to as a “character object” for description purposes.

The character object 650, unlike the text 611 and 612 having dialogue attributes, does not have a fixed format and may be variously disposed within the translation target image file 600, and may have a variety of visual appearances (e.g., font, size, tilt, color, shading, etc.). Such character object 650 may be unrecognized by a character recognition algorithm (e.g., OCR). To this end, in the present invention, a user environment and translation process that consider even the character object 650 may be provided on the basis of image capture.

The translation server 110, in response to receiving a control command for capture of at least a portion of the translation target image file 600 output in the first area 710 of the translation editor 700, may generate and provide an input window for receiving the translated language for the captured image to the second area 720. In this case, the captured image may be disposed on one side of the input window for receiving the translated language for the captured image as input in the second area.

For example, as illustrated in FIG. 7A, the first area 710 of the translation editor 700 may include a functional icon (e.g., capture 711) linked to an image capture function for the translation target image file 600. The translation representative may select the functional icon 711 to capture an image 660 that includes a character object (e.g., “ [symbol] ”) when the character object (e.g., “ [symbol] ”) that has not been extracted from the translation target image file 600 exists within the translation target image file 600. The translation server 110 may specify the captured image 660 as a translation target and proceed with data processing so that a translation task for the captured image 660 is carried out by the translation representative.

More specifically, as illustrated in (a) of FIG. 7B, the translation server 110 may receive a request for a translation task for a specific episode from the translator terminal. For example, the translation server 110 may, on the basis of at least one of the translation target episodes allocated to the translator being selected from the task page 500, receive a request for a translation task for the selected specific episode.

As illustrated in (b) of FIG. 7B, in response to receiving a request for the translation task for the specific episode from the translator terminal, the translation server 110 may provide the translation editor 700 to the translator terminal so that the translated episode for the translation target image file 600 of the specific episode is generated. As described above, the first area 710 of the translation editor 700 may output the image file 600 of the translated episode, and the second area 720 may include an input window 722 for a text (e.g., “ [symbol] !!”, 612) extracted from the translation target image file 600. Further, in the third area 730, a translation support tool (e.g., glossary 730a) may be output.

The translation server 110 may receive a control command to capture at least a portion of the translation target image file 600 through the first area 710, while at least a portion of the translation target image file 600 is being output in the first area 710 of the translation editor. For example, on the basis of the image capture function icon 711 displayed in the first area 710 being selected, the translation server 110 may control a capture tool to be executed in the first area 710.

As illustrated in (b) of FIG. 7B, while the capture tool is executed, the translation representative may specify (or select) an area that includes the character object (e.g., “ [symbol] ”). The translation server 110 may receive a control command from the translator terminal to capture an image 660 of at least a portion of the translation target image file 600, on the basis of a user input specifying at least a portion of the first area 710 while the capture tool is in an executed state. As such an example, the control command for capturing the image may be a drag input that starts at a first point of the image file and ends at a second point thereof.

As illustrated in (c) of FIG. 7B, in response to receiving the image capture command from the translator terminal, the translation server 110 may control such that at least one input window 723 for the captured image 660 is generated in the second area 720 of the translation editor. In this case, the translation server 110 may determine a generation position of at least one input window 723 for the captured image 660 on the basis of a relative position of the captured image 660 and the text (e.g., “ [symbol] ”, 612) extracted from the translation target image file 600, allowing the translation representative to intuitively recognize the sequence of translation targets (extracted text or captured image). For example, assume that a position of the captured image 660 within the translation target image file 600 corresponds to the sequence after (or following) a specific text (e.g., “ [symbol] ”, 612). The translation server 110 may control such that the input window 723 for the captured image 660 is generated in the second area 720, which corresponds to a position below the translated language input window 722 for the specific text (e.g., “ [symbol] ”, 612).

Meanwhile, the input window 723 for the captured image 660 may include a plurality of input windows 723a and 723b, which receive different types of languages. With reference to the second area 720 of the translation editor 700 in FIG. 7A, the input window 723 for the captured image 660 may include an input window for receiving the translated language (the language of the second country) for the captured image (hereinafter, which may be referred to as “translated language input window” or “translated text input window,” 723a) and an input window for receiving the original language (the language of the first country) for the captured image (hereinafter, which may be referred to as “original language input window” or “original text input window,” 723b).

In response to receiving an image capture control command from the translator terminal, the translation server 110 may generate the translated language input window 723a and the original language input window 723b for the captured image in the second area 720 of the translation editor. That is, unlike the text 611 extracted from the translation target image file 600, the translation server 110 may generate a plurality of input windows 723a and 723b of different types for the captured image 660.

Further, the translation server 110 may dispose the captured image 660 in a surrounding area of the translated language input window 723a and the original language input window 723b for the captured image, within the second area 720 of the translation editor.

As described above, in the second area 720, there may exist input windows matched to each of the plurality of texts extracted from the translation target image file 600 (e.g., “ [symbol] [symbol] ?”, “ [symbol] ”, 611, 612). The translation server 110 may output a text matched to an input window around the input window, allowing the translation representative to intuitively recognize which text the translation representative is proceeding with the translation task on. Similarly, the translation server 110 may dispose the captured image 660 around the input window 723 for the captured image, allowing the representative to intuitively recognize that it is a translation task for the captured image.

In this case, the translation server 110 may set the position of the captured image 660 in the second area 720 on the basis of a point in the first area 710 where the image capture control command is applied. The point at which the control command is applied may be a starting point or endpoint of the drag input, or a reference point calculated using the starting point or endpoint.

More specifically, the translation server 110 may output image capture and position information on the captured image 660 on the basis of the point in the first area 710 where the image capture control command is applied. The translation server 110 may specify the relative positions between the captured image 660 and the extracted texts 611 and 612 on the basis of the position information on the captured image 660. The translation server 110 may, on the basis of the relative position of the captured image 660, determine the output positions for the translated language input window 723a for the image 660 captured in the second area 720, the original language input window 723b, and the captured image 660.

Meanwhile, the translation server 110 may provide the original language input window 723b for inputting an original language corresponding to the language of the first country of a translated language between the captured image 660 and the translated language input window 723a that receives the translated language for the captured image 660. The translation server 110 may dispose the captured image 660, the original language input window 723b, and the translated language input window 723a in the second area 720, aligned sequentially along one direction.

By disposing the translated language input window 723a for the captured image 660, the original language input window 723b, and the captured image 660 side by side along one direction, the translation representative may be guided to perform the translation task in the order of captured image-original text-translated language.

For example, as illustrated in (a) of FIG. 7C, the translation representative may identify the captured image 660 in the second area 720. Further, the translation representative may recognize a character object included in the captured image 660 and input an original language corresponding to the character object (e.g., “ [symbol] ”) into the original language input window 723b. The translation representative may proceed with the translation task of translating the original language inputted in the original language input window 723b into the language of the second country. As illustrated in (a) of FIG. 7C, the translation representative may translate the original language into the language of the second country, and input the translated language (e.g., “whoosh”) into the translated language input window 723a. As described above, the translation server 110 may dispose the captured image 660, the original language input window 723b, and the translated language input window 723a in the second area 720 in sequence, thereby guiding the translation representative to carry out the translation task in the order of captured image-original text-translated language.

As illustrated in (c) of FIG. 7C, the input window 722 for receiving the translation of the text (e.g., ‘ [symbol] ’, 612) extracted from the translation target image file 600 as input may be displayed in the second area 720 of the translation editor. The translation representative may input the translated language of the extracted text (e.g., ‘Yep!! ’) into the input window 722 of the translated language for the extracted text.

Meanwhile, the translation server 110 may provide a function to exclude the captured image 660 from the translation target. The translation server 110 may exclude (or delete) the captured image 660 from the translation target in response to receiving a delete control command for the captured image in the second area 720 of the translation editor.

As illustrated in (a) of FIG. 7D, the translation server 110 may display a function icon linked to the delete control command for deleting (or excluding) the captured image from the translation target (hereinafter referred to as “delete icon” 724) around the captured image 660 displayed in the second area 720.

As illustrated in (b) of FIG. 7D, the translation server 110 may change a visual appearance of an area 725 related to the captured image within the second area 720 on the basis of a predefined user input for the delete icon 724 (e.g., an operation of putting the mouse on the delete icon). For example, the translation server 110 may process the captured image 660 and the area 725 corresponding to the input window 723 for the captured image 660 to be dimmed, so that the translation representative may intuitively recognize the deleted captured image 660.

The translation server 110 may exclude the captured image 660 from the translation target in response to the delete icon 724 being selected while the area 725 related to the captured image is in a dimmed state. As illustrated in (c) of FIG. 7D, the translation server 110 may control the input window 723 for the captured image to disappear from the second area 720, interworking with the exclusion of the captured image 660 from the translation target.

Meanwhile, a review process for reviewing the translated language may be performed. As described above, the review process may include an “editing review,” which modifies and inputs the translated language, a “proofreading review” that uses messages on the translated language to provide feedback, and an “image review (lettered file review, final review, or QA review),” which performs a review of the lettered file. First, a review editor for editing review and proofreading review will be described, followed by a description of the review editor for image review (or lettered file review).

As illustrated in FIG. 8A, the translation server 110 may provide a review editor 800 for reviewing the extracted text and the translated language. In this case, the review editor 800 illustrated in FIG. 8A may be output in a popup form in the translation editor 700, overlapping the screen of the translation editor 700 illustrated in FIG. 7A, and may be provided to the review representative. The review editor output in a popup form may also be referred to as a review comparison window.

The review editor 800 may include at least one of a first area 810, a second area 820 and a third area 830. Comparison target images 811, 821, and 831 may be output in at least some of the first area 810 to the third area 830 of the review editor 800.

In the first area 810 of the review editor 800, an image file 811 of the translated episode including the language of the second country (translated language, e.g., “Whoosh”) may be output. Such an image file 811 of the translated episode may be the language of the first country included in the translation target image file being changed to the translated language, on the basis of the translated language being input through the input window in the translation editor 800.

An image file of the translation target (or translation target manuscript, 821, 831) including the language of the first country (original language, e.g., “ [symbol] ”) may be output in one of the second area 820 or the third area 830 of the review editor 800.

The reviewer may compare, through the review editor 800, the image file 811 of translated episode, which is created based on the language of the second country (translated language), with the translation target image files 821 and 831, which are created based on the language of the first country (original language), to review the translated language.

While comparing the image file 811 of translated episode with the translation target image files 821 and 831 proceeding with the review of the translated language, the reviewer may modify the translated language or add a new translation target on the basis of the capture function. For example, when there is a character object that was not output in the translation editor 700 (e.g., a character object hidden by a background layer, thus not output in the translation editor) or a character object that was not translated by the translation representative, the reviewer may add the corresponding character object as a translation target in the review editor 800 on the basis of the capture function.

To this end, as illustrated in FIG. 8A, the translation server 110 may provide a function icon (e.g., capture 822) linked to the capture function in the review editor 800. The translation server 110 may receive a control command for image capturing at least a portion of an image file output in the review editor 800 from the reviewer terminal, based on the function icon 822 being selected.

In response to receiving the capture command, the translation server 110 may provide a popup window 840 in at least a portion of the review editor 800, as illustrated in FIG. 8B. The popup window 840 may include a captured image 841, a translated language input window 842a for receiving the translated language for the captured image as input, and an original language input window 842b for receiving the original language for the captured image as input.

Hereinafter, for convenience of explanation, an example will be provided to describe in more detail the capture of the translation target image file 821 output in the second area 820 of the review editor.

As illustrated in (a) of FIG. 8C, while the image file 811 of translated episode is output in the first area 810 of the review editor, and the translation target image file 821 is output in the second area 820 of the review editor, the translation server 120 may receive a user selection for the image capture function icon 822 displayed in the second area 820 from the review editor. The translation server 120 may, on the basis of the image capture function icon 822 being selected, control a capture tool to be executed in the second area 820.

As illustrated in (b) of FIG. 8C, while the capture tool is executed, the review representative may specify (or select) an area that includes the character object (e.g., “ [symbol] ”). The translation server 110, while the capture tool is in an executed state, may receive, from the reviewer terminal, a control command for capturing the image 841 of at least a portion of the translation target image file, on the basis of a user input specifying at least a portion of the second area 810 of the review editor.

As illustrated in (c) of FIG. 8C, in response to receiving the image capture command from the reviewer terminal, the translation server 110 may provide the popup window 840 for the captured image 841 in the second area 820 of the review editor. As described above, the popup window 840 may include a captured image 841 (FIG. 8B), a translated language input window 842a for receiving the translated language for the captured image as input, and an original language input window 842b for receiving the original language for the captured image as input.

The translation server 110 may receive the translated language and the original language for the captured image from the reviewer terminal through the popup window 840. The translation server 110 may update the translated language and original language received from the translation representative on the basis of the translated language and original language received from the reviewer terminal.

The translation server 110 may generate a translation file on the basis of the information received from at least one of the translator terminal or the reviewer terminal. Hereinafter, for convenience of description, an example will be provided where a translation file is generated on the basis of the information received from the translator terminal. However, when the information (translated language and original language) received from the translator terminal has been updated on the basis of the information received from the reviewer terminal, the translation server 110 may generate a translation file using the updated information.

The translation server 110 may receive the translated language for the text extracted from the translation target image file 600 from the translator terminal. In addition, the translation server 110 may receive the original language and the translated language for the captured image 660 from the translation target image file 600, from the translator terminal.

The translation server 110 may generate a translation file for the translation target image file 600 using the extracted texts 611 and 612, the translated language for the language of the second country for the extracted texts, and the translated language and original language for the captured image 660.

In the present invention, the “translation file” may refer to a file provided to the lettering design representative responsible for a lettering task of the translated language. In this case, lettering may refer to replacing characters in the image file with characters in another language.

As illustrated in FIG. 9, the translation server 110 may generate a translation file 500d that includes a data set 570 for extracted text (e.g., “ [symbol] ”, 571) and a data set 570′ for a captured image 577. The translation server 110 may generate the data set 570 for the extracted text by matching at least some of the language of the first country (e.g., “ [symbol] !!”, 571), the translated language corresponding to the language of the first country (e.g., “Yup!!”, 572), information on the episode of the content from which the language of the first country was extracted (e.g., “Yumi's Cells Episode 23”, 573), or position information on the extracted language within the episode. Further, the translation server 110 may configure the data set 570′ for the captured image by matching at least some of the captured image 577, the translated language for the captured image (e.g., “whoosh”, 574), the original language for the captured image (“ [symbol] ”, 576), episode information corresponding to the captured image (e.g., “Yuna's Cells Episode 23”, 575), or position information on the captured image.

The translation server 110 may generate the translation file 500d using the data set 570 for the extracted text and the data set 570′ for the captured image 577.

The translation server 110 may generate the translation file as at least one of a first type of file or a third type of file. The lettering designer needs to input (create, design, or sketch) the translated language in an area where the language of the first country was positioned, and the lettering designer should intuitively recognize a matching relationship between the language of the first country and the language of the second country, which is the translated language. Accordingly, the translation file may be generated as a third type of file having a table structure and provided to the lettering designer.

In the lettering designer terminal, a task may be performed to change the language characters of the first language included in the character layer, among the plurality of layers that make up the translation target image file, into the translated language, which is the language of the second country, on the basis of the translation file. The lettering designer terminal may generate a translated episode file (a lettered file or lettered image file) that is translated into the language of the second country, and the translation server 110 may receive the translated episode file (or lettered file) from the lettering designer terminal.

The translation server 110 may provide a final review editor to a final review representative terminal so that a final review of the translated episode file (lettered file or lettered image file) may be performed. In the present invention, the final review is referred to as “(lettered) image review,” “lettered file review,” “QA review,” or the like. Hereinafter, to avoid confusion of terms, the final review will be referred to as “QA review.” However, it is apparent that the QA review may alternatively be referred to as “image review,” “lettered file review,” “final review,” or the like.

As illustrated in FIG. 10A, the translation server 110 may provide a QA editor 900 to a QA representative terminal so that a review of the translated episode that is translated into the language of the second language may be performed. In a first area 910 of the QA editor 900, the lettered image file (lettered translated episode, 911) may be output, while in a second area 920 of the QA editor 900, a translation target image file (or translation target manuscript, 921) may be output. That is, the translation server 110 may output the translated episode, lettered in the language of the second country, in the first area 910 of the QA editor 900, and output the original episode, created on the basis of the language of the first country, in the second area 920 of the QA editor 900.

The QA representative may proceed with a final review by comparing the lettered translated episode with the original episode regrading whether the translation has been performed accurately and whether the lettering of the translated language has been done correctly. The QA representative may, on the basis of the results of the QA review, generate a review list in a third area 930 of the QA editor 900.

The translation server 110 may receive a control command for image capture of at least a portion of the lettered image file 911 output in the first area 910 of the QA editor 900. The translation server 110 may, in response to the control command for image capture, generate an input window (“message input window” or “feedback input window,” 932) in the third area 930 to allow inputting a feedback message for the captured image 931. Further, the translation server 110 may display the captured image 931 around the message input window 932.

As described above, a QA reviewer may capture a portion of the lettered image file 911 within the QA editor 900 that requires modification, and transmit a feedback message for the captured image 931 to at least one of the translation representative or the lettering designer. Hereinafter, assuming that an incorrect translated language is lettered into the lettered image file 911 (e.g., where the translated language “whoosh” for “ [symbol] ” is incorrectly lettered as “SIGH”), a method of transmitting a feedback message on the basis of the capture function will be described.

As illustrated in (a) of FIG. 10B, while the lettered image file is being output in the first area 910 of the QA editor and the translation target image file is being output in the second area 920 of the QA editor, the translation server 110 may receive a selection of an image capture function icon 912 displayed in the first area 910. The translation server 110 may, on the basis of the image capture function icon 912 being selected, control a capture tool to be executed in the first area 710.

As illustrated in (b) of FIG. 10B, while the capture tool is in an executed state, the QA representative may specify (or select) at least a portion of the lettered image file (e.g., a portion where the incorrect translated language “SIGH” is lettered). The translation server 110, while the capture tool is in an executed state, may receive, from the reviewer terminal, a control command for image capture of the image 931 of at least a portion of the lettered image file, on the basis of a user input specifying at least a portion of the first area 910 of the QA editor.

As illustrated in (c) of FIG. 10B, in response to receiving the image capture command from the reviewer terminal, the translation server 110 may control such that the feedback message input window 932 for the captured image 931 is generated in the third area 930 of the QA editor. Further, the translation server 110 may display the captured image 931 around the feedback message input window 932.

As illustrated in (d) of FIG. 10B, in response to a feedback message being input into the feedback message input window 932 for the captured image 931, the translation server 110 may transmit the feedback message to at least one of the translator terminal or the lettering designer terminal. In this case, the translation server 110 may also transmit the captured image 931 along with the feedback message to the translator terminal and the lettering designer terminal.

As described above, the method and system for performing content translation according to one aspect of the present invention, composed of a management server and a translation server, can achieve a more systematic and consistent overall process to translating and servicing the original work of a webcomic to other countries. That is, according to this aspect of the present invention, by efficiently designing the data processing flow among various entities, cooperation between webcomic service providers, translation providers, administrators, and others can be managed more systematically.

Further, the method and system for translating content according to another aspect of the present invention can receive an image file of a translation target related to an episode of content created on the basis of the language of a first country, extract text corresponding to the language of the first country from the image file, and provide a translation editor for the image file so that a translated episode based on the language of a second country different from the first country is generated using the image file. The user of the first terminal may be provided with an efficient translation environment optimized for translation by the system, and the system may receive, from the first terminal, the translation results that is translated from the language of the first country to the language of the second country.

Further, in the method and system for translating content according to still another aspect of the present invention, the translation editor may include a first area where the image file of the translation target is output and a second area for receiving tlhe translated language in the language of the second country for the extracted text as input. The translation representative may proceed with the translation task using a single translation editor without needing to switch between multiple programs.

Further, in the method and system for translating content according to yet another aspect of the present invention, an input window for receiving the translated language for the captured image as input may be generated in the second area, in response to a control command for image capturing at least a portion of the image file output in the translation editor received through the first area. Therefore, in the present invention, the translation task may proceed even for characters not extracted from the episode, such as dialogue, sound effects, character emotions, and descriptions, thereby improving translation quality.

Meanwhile, the computer-readable medium includes all kinds of storage devices for storing data readable by a computer system. Examples of computer-readable media include hard disk drives (HDDs), solid state disks (SSDs), silicon disk drives (SDDs), ROMs, RAMS, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. A method of translating content, comprising:
receiving an image file of a translation target related to an episode of content created based on a language of a first country;
extracting text corresponding to the language of the first country from the image file; and
providing a translation editor for the image file so that a translated episode of the episode is generated on the basis of a language of a second country different from the first country using the image file,
wherein the translation editor includes a first area in which the image file of the translation target is output, and a second area for receiving a translated language in the language of the second country for the extracted text as input, and
wherein, in response to a control command for image capturing at least a portion of the output image file received through the first area, an input window for receiving a translated language for the captured image as input is generated in the second area.

2. The method of claim 1, wherein the captured image is disposed on one side of the input window for receiving the translated language for the captured image as input in the second area.

3. The method of claim 2, wherein an input window for inputting an original language corresponding to the language of the first country of the translated language is provided between the captured image and the input window for receiving the translated language for the captured image as input.

4. The method of claim 3, further comprising:
generating a translation file for the image file of the translation target using the extracted text, the translated language in the language of the second country for the extracted text, the translated language for the captured image, and the original language.

5. The method of claim 2, wherein a position of the captured image in the second area is set on the basis of a point at which the control command for image capturing is applied in the first area.

6. The method of claim 2, wherein an icon for receiving a control command to delete the captured image is output in the second area.

7. The method of claim 1, wherein the extracted text and an input window for inputting the translated language in the language of the second country for the extracted text, is displayed in the second area.

8. The method of claim 1, further comprising:
providing a review editor for reviewing the extracted text and the translated language to perform a review of the translated language,
wherein, in response to a control command for image capturing at least a portion of an image displayed in the review editor received through the review editor, an input window for receiving a translated language corresponding to at least a portion of the captured image as input is generated in the review editor.

9. The method of claim 1, wherein the translated episode is output in the first area, and the image file of the translation target is output in the second area so that a review of the translated episode is performed.

10. The method of claim 9, wherein, in response to a control command for image capturing at least a portion of the translated episode received through the first area, a review list is generated in a third area that is positioned differently from the first area and the second area.

11. A system for translating content, comprising:
a management server configured to register an image file of a translation target related to an episode of content created on the basis of a language of a first country;
a translation server configured to receive the image file of the translation target,
wherein the translation server provides a translation editor for the image file so that a translated episode of the episode is generated on the basis of a language of a second country different from the first country using the image file,
wherein the translation editor includes a first area in which the image file of the translation target is output, and a second area for receiving a translated language in the language of the second country for text extracted from the image file of the translation target as input, and
wherein, in response to a control command for image capturing at least a portion of the output image file received through the first area, an input window for receiving a translated language for the captured image as input is generated in the second area.

12. The method of claim 11, wherein the captured image is disposed on one side of the input window for receiving the translated language for the captured image as input in the second area.

13. A non-transitory computer-readable recording medium storing a program, which when executed by one or more servers in an electronic device, enables the electronic device to execute the steps comprising:
receiving an image file of a translation target related to an episode of content created based on a language of a first country;
extracting text corresponding to the language of the first country from the image file; and
providing a translation editor for the image file so that a translated episode of the episode is generated on the basis of a language of a second country different from the first country using the image file,
wherein the translation editor includes a first area in which the image file of the translation target is output, and a second area for receiving a translated language in the language of the second country for the extracted text as input, and
wherein, in response to a control command for image capturing at least a portion of the output image file received through the first area, an input window for receiving a translated language for the captured image as input is generated in the second area.
